(19) United States
(12) Patent Application Publication
(10) Pub. No.: US 2005/0050018 A1
(43) Pub. Date: Mar. 3, 2005

(54) Data structure supporting session timer and variable aging function including self adjustable 2MSL

(75) Inventors: Claude Basso, Raleigh, NC (US); Gordon T. Davis, Chapel Hill, NC (US); Marco Heddes, Shelton, CT (US); Dongming Hwang, Apex, NC (US); Colin B. Verrilli, Apex, NC (US)

Correspondence Address: DRIGGS, LUCAS BRUBAKER & HOGG CO. L.P.A., DEPT. IRA, 8522 EAST AVENUE, MENTOR, OH, 44060, US

(73) Assignee: International Business Machines Corporation, Armonk, NY (US)

(21) Appl. No.: 10/654,502

(22) Filed: Sep. 3, 2003

(51) Int. Cl. G06F 17/30

(52) U.S. Cl. 707/3

(57) ABSTRACT

Dynamic data search structures are described that are capable of handling large numbers of active entries and a high rate of additions and deletions of active entries while complying with 2MSL requirements and providing precise time-out capabilities. A free queue which is integrated with the timing loop of session entries provides available sessions for new entries in the search structure and removes obsolete sessions from the tree. Multiples of such timing loops can be used to maintain multiple timing intervals. One such timing loop may contain soft entries still attached to the search structure but which are eligible to be removed and to be reused to accommodate new sessions. A spare buffer pool is also included in the data structure to add and remove buffers to maintain delays.

### CROSS-REFERENCE TO RELATED APPLICATIONS

This application is related to copending and commonly assigned patent application, U.S. Ser. No. 09/543,531, docket number RAL919990139US1, filed Apr. 6, 2000 and entitled “Full Match (FM) Search Algorithm Implementation for a Network Processor”, and patent application entitled “Data Structure Supporting Random Delete and Aging/Timer Function”, docket number RPS920020070US1, filed simultaneously herewith, the contents of which are incorporated hereinto.

### BACKGROUND OF THE INVENTION

1. Field of the Invention

This invention relates to the specific area of computer technology associated with the data structures useful in networking tasks. More specifically, it relates to dynamic data search structures that add large numbers of active file entries to data tables or delete such file entries from these tables.

2. Discussion of Related Art

To assist in the understanding of the present invention and related art, the following abbreviations and acronyms used herein are defined as follows:
ACK—Acknowledgement
Active Session—data entry being sought in data structure containing data associated with a session that is currently sending and receiving packets.
Chained pointers—pointers within data objects that create a linked list of such objects.
Data structure—grouping of related table entries
DT—direct table
FIN—finish
FM—fill match
FQ—free queue
Hashing—reducing the network portion of an address to a manageable index
MAC—media access control
MSL—maximum segment lifetime
NP—Network Processor
Patricia tree—A table structure associated with binary searching techniques wherein all address strings and accompanying information are stored in a binary tree
PSCB—pattern search control block
TCB—timer control block
TCP—transmission control protocol

Many commonly used networking tasks are organized by structuring various data bases (i.e. routing tables, active session state, etc.). Hash tables are often used with various mechanisms for resolving the case of multiple entries hashing to the same location (i.e. Patricia tree via chained pointers or “pattern search control blocks” (PSCBs) to the desired entry). Organization and maintenance of these data structures varies significantly according to the associated applications. In a first class, many of these data structures are static (at least when viewed over a short period of time), and are updated by a network administrator only in response to occasional network configuration changes, if at all. In a second class, routing tables may be updated based on communications with other routers in the network. There is a third class of data structures. These data structures may be characterized as dynamic, responding to normal data traffic by adding entries useful in processing subsequent traffic sharing some specific characteristics. Examples of such data structures include layer 2 MAC address tables used in bridging functions, and various session-based data structures. Since a session entry is kept only as long as a session is active, session-based structures are likely the most dynamic and, therefore, create the biggest challenge.

One specific challenge with dynamic tables is that these data structures will eventually get full. Even if there are basic procedures (i.e. detection of the end of a session) to remove obsolete entries, an occasional missing packet can cause these data bases to grow without bound, eventually overflowing available memory. A standard technique for controlling the total number of entries is to apply various aging or timer functions to active entries. These mechanisms test each active entry periodically to determine how long it has been since it was last used.

FIG. 1 illustrates a basic data search structure capable of providing an aging or timer function. This structure is based on a full match (FM) hash table algorithm described separately in said related patent application U.S. Ser. No. 09/543,531. This data structure consists of a direct table (DT) 100 to which a hashed search key (not shown) is applied, with a tree structure 104 of pointers to resolve collisions in each DT entry. For a given search key, a chain of pointers, called pattern search control blocks or PSCBs 106 in the tree structure will lead from the DT to the desired data, shown in the Figure as “active sessions” 108. All of the active sessions are linked together in a loop, enabling a timer or aging function to step through all active sessions sequentially, looking for entries that have outlived their usefulness. This aging function not only points to the next active session to test, but also controls the insertion point for new sessions and the deletion point for obsolete sessions. As required, a new session 130 is established by moving an entry from the head 110 of the free queue 116 to the insertion/deletion point 112 in the main structure 104. Likewise, an obsolete session is moved from the insertion/deletion point in the tree structure 104 to the tail 114 of the free queue 116.

A limitation with the structure illustrated in FIG. 1 relates to the accuracy of any timer functions implemented. Typically, when a timer is started (or restarted), a timeout value is added to a real-time time stamp and written to the session entry. Then a timer support process examines each entry in the sequence determined by the loop of chained pointers, comparing the timer entry with the current time-stamp value. However, the timer support task is most likely not synchronized to the session timers. Then, in the worst case, the timer support process may have to test every entry in the loop between the time the timer of a specific session actually expires and the time the session is actually tested. For a large data structure (one million entries) this could take hundreds of milliseconds. Conversely, the timer or aging process may have to read and test a given session entry for time-out multiple times before the timer actually expires, adding to the bandwidth utilization of the memory bus and resulting in a corresponding increase in contention for access to that memory resource.

In some applications, it may be desirable to maintain a session entry after the session is terminated, within the limits of the storage capacity of the processing system. This may be useful in the case where a new session is established with the same parameters that were used for a previous session. In this case, session establishment may be simplified by making use of a session state previously used by the same flow. In such an implementation, it would be desirable to modify the structure of FIG. 1 to age out entries only as fast as new entries are required, thus maximizing the use of storage capacity to retain previous session context.

The TCP protocol requires that hosts maintain session information for a maximum segment lifetime (MSL) for sessions that have seen a FIN packet and sent a FIN packet. The Internet Engineering Task Force (IETF) Request For Comments (RFC) 793 specifies the MSL as two minutes. This requirement is for the exceptional case in which the final ACK is lost in the network and the remote host would retransmit its FIN. Sessions in this state are said to be in the 2MSL state. This specification is not usually a problem for end systems whose number of sessions in the 2MSL state is relatively small. For load balancer devices which manage TCP sessions for many thousands of host systems at rates of 10,000s of new sessions per second, this requirement becomes significant. The storage required to store two minutes worth of “old” sessions becomes very large. Furthermore, when load balancer software is moved to Network Processors where the memory available for session tables may be limited, this requirement can become a severe limiting factor to the desired session rate (which would otherwise be obtainable with the performance capability of NPs).

### SUMMARY OF THE INVENTION

It is an objective of the present invention to provide enhanced data search structures that efficiently handle large numbers of active entries with a high rate of session addition and deletion.

It is a further objective of the present invention to maximize the memory resources available for active sessions and to minimize the performance impact both from code actions and from memory bandwidth utilization.

Another objective of the subject invention is to support more precise time-out capabilities.

Yet another objective is to allocate new session entries from those in the maximum segment lifetime (MSL) state, such as 2MSL, when the free list of session entries has no entries available.

One aspect of the present invention is to include the free queue of session entries in the same timer loop used for timer control blocks assigned to active sessions, thus minimizing the overhead for insertions.

Yet another aspect is to partition the timing loop into multiple shorter loops, each with its own timer support task in order to better support different time-out values or different expected packet response times for different packet types. An additional feature is for the system to provide for new session entries even though the free queue is empty. This is achieved by maintaining a separate timer loop of “soft entries” that can be removed from the 2MSL state to make room for new session entry information. The oldest soft entry is removed from the list.

An additional aspect of this invention is the dynamic adjustment of the number of empty entries in the timer loop(s) in order to better control the accuracy of the timer process. Still further, the free queue for active sessions is organized in order of session age, enabling a cache function of terminated sessions for applications that might expect repeat sessions between the same client and server.

An additional feature is for the system to provide 2MSL state entries even though the free queue is full. This is achieved by maintaining a FIFO list of soft entries that can be removed from the 2MSL list to make room for new connection entry information into the 2MSL by removing the oldest soft entry in the FIFO list.

The invention also relates to a method for managing dynamic data search structures such as those in a search tree. The method includes providing a data search structure containing multiple data entries with at least one data entry associated with said structure. An association is established between each data entry and a corresponding timer control block. The data search structure typically comprises a direct table, and a search tree with at least one pattern search control block (PSCB) associated with each of the data entries in the direct table. At least one data entry comprising an active session is associated with at least one of said pattern search control blocks or one of the direct table entries. A first timer loop is provided to maintain active sessions and a second timer loop is provided to receive and maintain sessions that are no longer active. These sessions in the second loop are normally retained in a maximum segment lifetime (MSL) state. A free queue is provided for the first timer loop. This free queue includes available sessions for new entries in the search tree and removes obsolete sessions from the search tree. A free queue is provided for the second timer loop so that an active session can be moved from the active state to the MSL state. The method also includes the further step of providing a FIFO list of MSL entries. The oldest MSL entry is then removed to accommodate information on a connection entry for the most recently deleted session entry. A pool of spare buffers can also be provided for adjusting timer requirements in the first and the second free queues.

The invention also relates to data search structures wherein the data entries comprise active entries, and one or more soft entries that are in a maximum segment lifetime state and that are available for use for new entries. The active entries are chained together to form one timing loop, and the soft entries are chained together to form another loop. One or more available entries are used for new entries ahead of soft entries. These available entries are outside of the two loops and are chained to one another in a FIFO queue that determines their availability for use for new entries. The soft entries are chained together in a second FIFO queue and are used in that order for a new entry if the list of available entries in the queue of available entries is empty.

The invention also relates to a computer implemented medium for providing the instructions for moving obsolete sessions from an active list to a 2MSL soft entry and to maintain a FIFO list of soft entries. The instructions also enable the oldest entry on the FIFO list to be removed to make room for a new session.

### BRIEF DESCRIPTION OF THE DRAWINGS

FIG. 1 shows a basic data structure used for aging or timer functions;

FIG. 2 shows a data structure useful with the present invention;

FIG. 3 shows a table entry format associated with FIG. 2;

FIG. 4 shows a data structure with another element of the present invention for handling 2MSL entries;

FIG. 5 shows a simplified structure of FIG. 4;

FIG. 6 is a flowchart for adding a new session entry;

FIG. 7 is a flowchart for moving an entry to the 2MSL state;

FIG. 8 shows the deletion of an entry; and

FIG. 9 shows a computer readable medium in the form of a floppy disc.

### DETAILED DESCRIPTION OF THE INVENTION

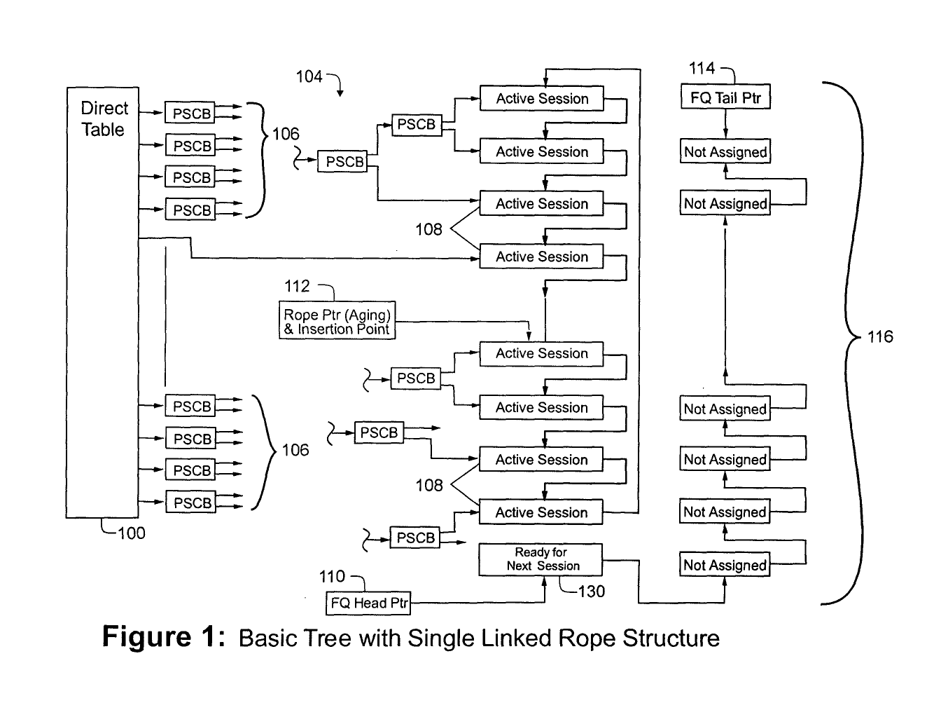

As mentioned previously, FIG. 1 shows the use of random session deletes. The drawbacks of this approach were also previously explained.

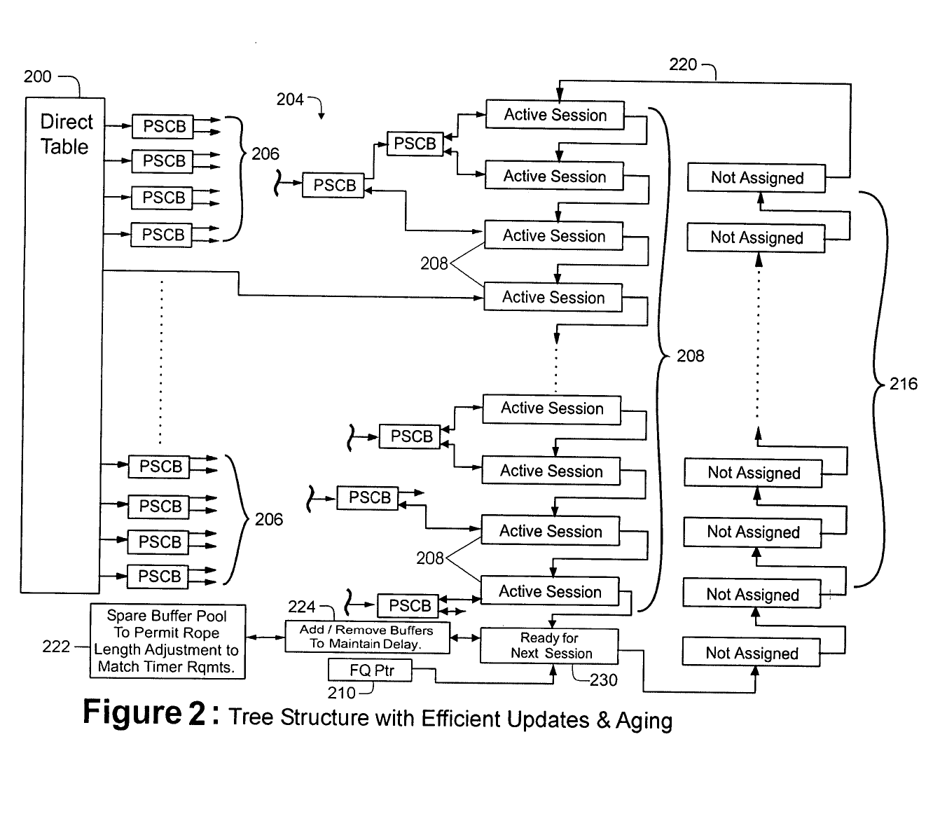

These problems are overcome with the present invention as shown in FIG. 2. In mapping from a search key to a corresponding active session entry, this data structure 204 uses the same direct table 200 and pattern search control block structure 206 illustrated in FIG. 1. The most significant difference is that the free queue 216 is merged with active sessions 208 into a larger timing loop 220. This simplifies insertions and deletions significantly, since there is no longer a requirement to rechain the session entry. An insertion simply requires an advancement of the free queue pointer 210 and modification of the tree structure to connect a PSCB to the entry of a new session 230. A deletion simply detaches the PSCB and allows the obsolete entry to flow into the tail (not shown) of the free queue section of the loop. Also different is the use of a spare buffer pool 222 to add and remove buffers at 224 to maintain delays.

Timer management is significantly different than in the data structures of FIG. 1. When restarting a timer, rather than writing the new timer value to the active session entry, the entry (with new timer value) is written to a new session entry pulled from the free queue. To facilitate this process, the session maintains a backward pointer to the PSCB. This enables easy modification of the PSCB to point to a new session entry when a timer restart action is performed. Recirculation of a session to a new entry insures that all timer values will be in sequential order. Thus, the timer support process can stall at a specific session in the timer loop, waiting until its timer value is less than the current time-stamp. Once synchronized to the session timers in the loop, the timer process proceeds to process timers in the order of the timer loop, without concern for one session blocking an earlier time-out of some other session. Another aspect illustrated in FIG. 2 is that the timer process may not explicitly step through the timer loop. In fact, the timer process may be merged with the processing of normal packet traffic by simply declaring a session timer expired when some other session uses its entry. For a fixed number of entries in the timer/aging loop, this would have the effect of a variable aging interval that is automatically adjusted based on current dynamics to age out old sessions at exactly the rate new sessions require resources.

FIG. 2 also illustrates an optional feature to add or delete blocks of empty session entries to adjust the total size of the timing loop. This may be desirable to achieve a more precise time-out of obsolete sessions. Thus, by generating an error signal determined as the difference between a time-out value and the current real-time time-stamp, the size of the timing loop can be controlled by adding or deleting empty session entries in proportion to the error signal. Preferably, control theory should be applied to filter the error signal to avoid responding to bursty behavior of the system.

The system illustrated in FIG. 2 can easily be extended to support two or more separate timer loops, each of which is consistent with the description above. This is desirable when two or more distinct time-out values are typically used. For example, it may be desirable to have one time-out value for client response time and another value for server response time. Alternately, one may implement a separate timing loop for each phase of a TCP session. In either case, receipt of a new packet might require that the session entry relating to the new packet be removed from its current timing loop and placed on a subsequent timing loop. This can be accomplished by simply copying the session contents to an entry in the new timing loop, and marking the old one for deletion. In the case of multiple timing loops, the loop size adjustments suggested above may be coordinated among the timing loops instead of (or in addition to) adjustments between the active loop(s) and a spare buffer pool.

From the perspective of the free queue head pointer, the ordering of time-out values leads to a convenient property of the free queue. Because of this ordering, the empty entry at the head of the queue represents the least recently used (oldest) entry. This facilitates the implementation of a cache function for terminated sessions that might be applicable to a subsequent session between the same client and server. To make use of this cache function, a session termination action would leave the PSCB connected to the session entry. Then, if a subsequent session matched the session definition, routing information from the old session entry could be used to reduce the overhead of setting up the new session. Optionally, an explicitly terminated session might be recirculated with a restarted timer value in order to lengthen the time this session data will be retained. This becomes a trade-off between memory utilization and efficiency of setting up new sessions.

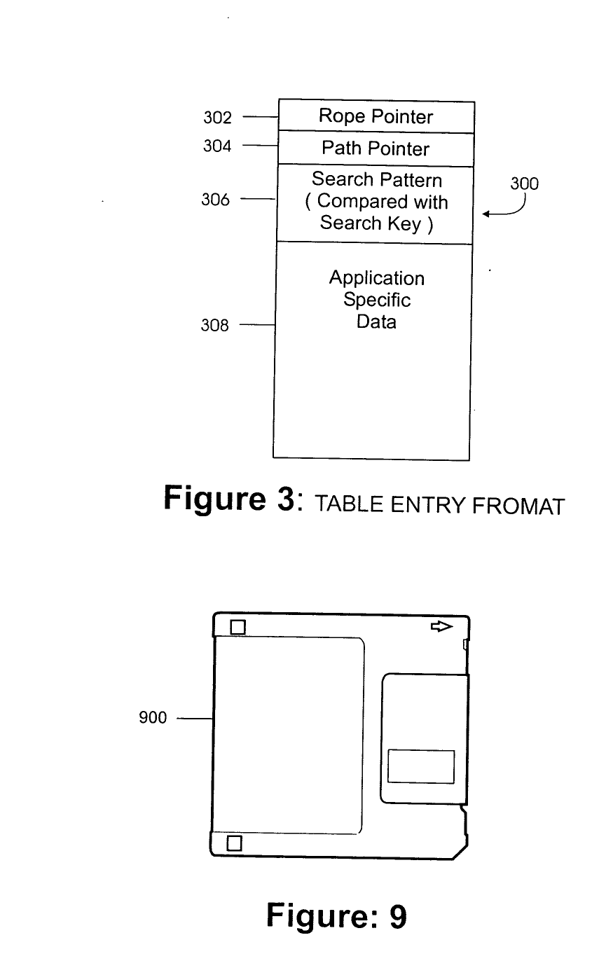

FIG. 3 illustrates a typical format (300) for each session entry. Note that in addition to the rope pointer (302) used to build the timing loop, a path pointer (304) is provided to point to the immediately connected PSCB or DT entry to facilitate recirculation of session entries during timer restart actions. As with other standard tree entry formats, the search pattern field (306) keeps a copy of the search key to validate a match during search actions. The application specific data block (308) shows the remaining fields of each entry that are unique to a particular application. These may contain routing information, address translation and other frame alteration information, session state, timer values, etc.

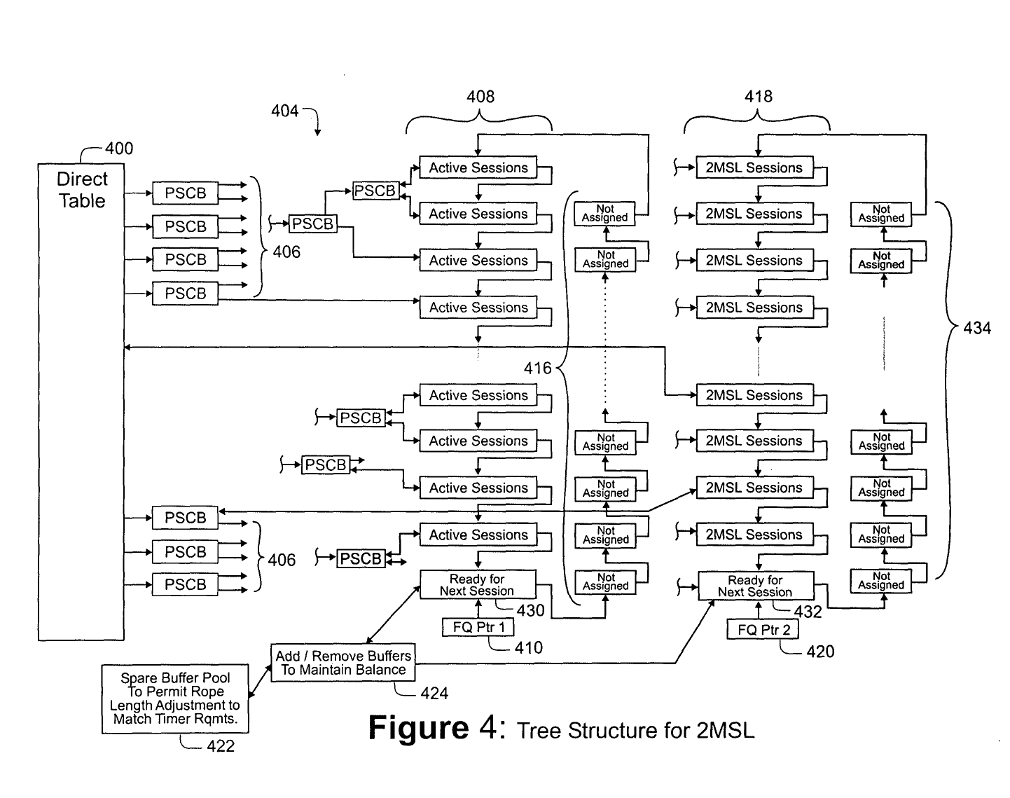

One particular application of this invention is now discussed. This application applies to TCP sessions in the 2MSL state. A tree similar to that shown in FIG. 2 is used to maintain the TCP session entries. The tree is extended, however, to contain two timer loops as described above. FIG. 4 shows the extended tree 404 with two separate timer loops. The first timer loop is used to maintain the active sessions 408. The second timer loop is used to maintain those sessions in the 2MSL state 418. A free queue pointed to by free queue pointers exists for each timer loop. When a new session is created, the first entry from the first free queue (ready for the next session 430) is used. The session information is filled and the free queue pointer 410 is moved to the next free entry. The new entry is added to the PSCB chain.

When a session is moved from the active state to the 2MSL state, the first entry from the second free queue 420 (ready for the next session 432) is used. The relevant contents of the active session entry are copied to the new entry and the second free queue pointer is advanced. The old entry is removed from the PSCB chain and the new entry is added to the PSCB chain at the same spot.

The second timer loop contains entries in the order that they entered the 2MSL state. It should be noted that the normal transition of session entries is from the active state to the 2MSL state and then to the free (not assigned) state. Because of this, the free queue of the first timer loop will naturally be depleted and must be replenished from the second timer loop. An important aspect of this invention is that if no empty (not assigned) sessions are available on the second timer loop, the oldest 2MSL session can be used. For this reason, the entries in the second list are called “soft entries” because they are still part of the tree, but they are eligible for removal. The use of soft entries may prematurely shorten the 2MSL state but this is preferable to refusing the new session. In order to reuse an entry in the 2MSL state, the entry would need to be removed from the PSCB chain. The entry would then be removed from the second timer loop and inserted into the first timer loop. Note that this movement could be performed by a background task or at the time that a new session needs to be created.

Alternatively, the 2MSL list could be implemented without the enhanced data structure of FIGS. 2 and 3. Here, it is assumed that there is a Patricia type fixed match (FM) search tree of active TCP sessions similar to that of FIG. 1; however, this invention applies to any type of search tree and to other types of search structures. This search tree includes session entries in the 2MSL state. There is also one free queue of available session entries (that have either never been used or have exited the 2MSL state). An additional first-in, first-out (FIFO) queue is maintained of session entries in the 2MSL state. The NP TCP code adds a session entry to this list when the 2MSL state is entered. So the list contains entries for sessions that are in the 2MSL state in the order that they entered this state. In addition, all entries in this list are still attached to the session search tree. These entries are called “soft entries” because they are still part of the tree, but they are eligible for removal. If a new session must be established requiring an entry and no entries are available in the “available” list, then the oldest “soft entry” can be reused for the new session. This would prematurely shorten the 2MSL state—but this is preferable to refusing the new session. In order to reuse the entry, the Pico code that required the entry first needs to delete it from the FM search tree, update the entry information, and then insert it in the FM tree at its new location.

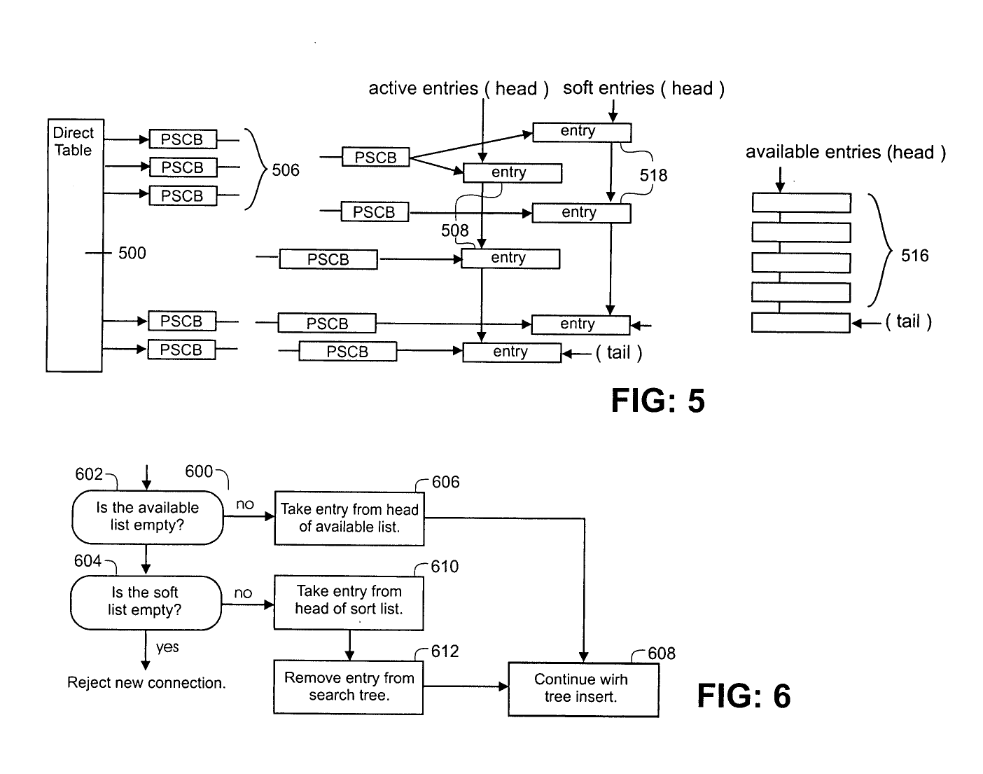

FIG. 5 is a simplified illustration of FIG. 4 and shows the search tree and free queues. The search tree is represented by a direct table (DT) 500, chains of pattern search control blocks (PSCBs) 506, and leaves or session entries 508, 516 and 518. The exact structure of the tree is not important for this disclosure, but this is one example. The entries are chained in three separate lists, the “active session” list 508, the “soft” list 518 and the “available” or not assigned list 516. Entries on the active list 508 are attached to the search tree and are not eligible for removal from the tree. Entries on the soft list 518 are also attached to the search tree but are eligible to be reused by new entries on a FIFO basis. Entries on the available list 516 are not attached to the tree and are freely available for use for new entries. Again, the search tree can be replaced with other types of dynamic data search structures.

A flowchart 600 for adding a new session entry to the search tree of FIGS. 4 and 5 is shown in FIG. 6. The first step is to determine at 602 if the available list (the free queue) has any entries or if it is empty. If the available list is not empty, then an entry is taken at 606 from the head of the available list and is inserted at 608. If the available list is empty, then the soft list of 2MSL sessions is checked at 604 to see if it is empty. If it is, the new session is rejected. If it is not empty, then an entry is taken from the head of the soft list at 610 and is removed from the search tree at 612. Then the process of inserting the new entry into the search tree is continued at 608.

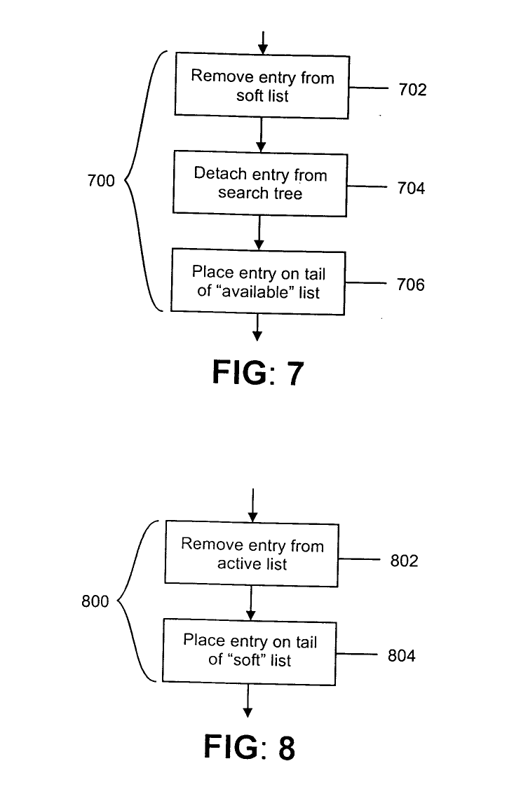

A flowchart for moving a 2MSL entry from the soft list to the available list is shown in FIG. 7. Here, an entry is removed from the soft list at 702 based on the unavailability of any entries in the free queue. The entry is then detached from the search tree at 704 and is placed on the tail of the available session list at 706. This then creates an opening to remove an entry from the active list at 802, placing the entry on the tail of the soft list 804 as shown in FIG. 8.

FIG. 9 shows a computer-readable medium in the form of a floppy disc 900 for containing the software implementation of the program to carry out the various steps of the process according to the present invention. Other machine readable storage mediums, such as fixed hard drives, optical discs, magnetic tapes, semiconductor memories, such as read-only memories (ROMs), programmable (PROMs), are also contemplated as being used within the scope of the invention. The article containing this computer readable code is utilized by executing the code directly from the storage device, or by copying the code from one storage device to another storage device, or by transmitting the code on a network for remote execution.

The present invention is applicable to applications other than TCP where session entries move from a state of higher importance to a state of lesser importance. In the case of TCP, it is very important to keep sessions in the table before the 2MSL state. When sessions are in 2MSL, it is desirable to keep them in the search tree, but it is more desirable to allow new sessions.

Although the discussion has been directed to specific search structures, such as those using a direct table and pattern search control blocks, the invention is likewise useful with other search structures, such as hash tables, particularly large hash tables having serial resolution of collisions, and CAMs (content addressable memories), particularly tertiary CAMs. Likewise, any other search application with similar structures can take advantage of the unique features this invention.

In an alternate design where sessions have an infinite 2MSL time, there could be one free list which contains both the available and soft entries. In this case, a flag would need to be maintained in the entry which indicates whether the entry is connected to the search tree or not. When an entry is used from the free list, the flag must be examined to see if it needs to be removed from the search tree. After a period of time, the free list will contain only soft entries and all new sessions will result in the oldest entry being reused. This approach has the benefit of a simpler design, but the disadvantage that the tree is always “full”, possibly resulting in longer search times.

While the invention has been described in combination with specific embodiments thereof, there are many alternatives, modifications, and variations that are likewise deemed to be within the scope thereof. Accordingly, the invention is intended to embrace all such alternatives, modifications and variations as fall within the spirit and scope of the present invention as defined and limited by the appended claims.

1. A system for managing dynamic data search structures, comprising:
a) a search structure having at least one data entry comprising an active session,
b) a timing loop containing all active sessions in the search structure, and
c) a free queue for providing available sessions for new entries in the search structure and for removing obsolete sessions from said search structure, wherein the free queue is incorporated into a timing loop and has a pointer for adding new sessions at an insertion/deletion point in the loop and for moving obsolete sessions to the free queue in the loop.

2. The system according to claim 1 further including a provision for the adjustment of the number of entries in the timing loop in proportion to an error signal representing the difference between a time-out value and the current real-time stamp.

3. The system according to claim 1 further including the organization of the free queue according to the age of an active session.

4. The system according to claim 1 wherein the timing loop is partitioned into multiple shorter loops, each of which includes its own timer support task and free queue.

5. The system according to claim 1 wherein the data search structure comprises a direct table and pattern search control blocks (PSCBs) that are arranged in a tree structure.

6. The system according to claim 5 wherein an insertion advances the free queue pointer and connects a PSCB to a new session entry and a deletion detaches a PSCB and allows an obsolete entry to flow into the free queue wherein an empty entry at the head of the free queue represents the least recently used entry.

7. The system according to claim 6 further including a path pointer in the session entry to point to the most recently connected PSCB.

8. The system according to claim 7 wherein the PSCB remains connected to a terminated session entry.

9. The system according to claim 1 further including a provision for optionally recirculating a terminated session with a restarted timer value to increase the length of time that data in that session is retained.

10. The system according to claim 6 further including a FIFO of soft entries which are attached to the search tree, wherein the soft entries are eligible based on the oldest FIFO entry.

11. The system according to claim 10 wherein active entries attached to the search tree are not eligible for removal, entries in a free queue are available for immediate reuse and soft entries attached to the search tree are eligible for removal and reuse by new entries in the event no entries in the free queue are available

12. A method for managing dynamic data search structures, comprising the steps of:
a) providing a search structure having at least one data entry comprising an active session,
b) providing a timing loop containing all active sessions in the search structure, and
c) creating a free queue for providing available sessions for new entries in the search structure and for removing obsolete sessions from said search structure, wherein the free queue is incorporated into a timing loop and has a pointer for adding new sessions at an insertion/deletion point in the loop and for moving obsolete sessions to the free queue in the loop.

13. The method according to claim 12 wherein the data search structure is created by:
a) providing a data search structure composed of (1) a direct table containing multiple entries; (2) at least one pattern search control block (PSCB) associated with each of said entries in the direct table; and (3) at least one data entry comprising an active session associated with said at least one of said pattern search control blocks or one of said direct table entries; and
b) providing a free queue having available sessions for new entries in the search tree and for removing obsolete sessions from the search tree, wherein the free queue is incorporated into a timing loop for moving new sessions to an insertion/deletion point in the loop and for moving obsolete sessions from the loop to the free queue.

14. The method according to claim 13 further including the step of adjusting the number of entries in the timing loop in proportion to an error signal representing the difference between a time-out value and the current real-time stamp.

15. The method according to claim 13 further including organizing the free queue according to the age of an active session.

16. The method according to claim 13 including partitioning the timing loop into multiple shorter loops, each of which includes its own timer support task.

17. The method according to claim 13 wherein the insertion advances the free queue pointer and connects a PSCB to a new session entry and a deletion detaches a PSCB and allows an obsolete entry to flow into the free queue.

18. The method according to claim 13 wherein a path pointer points to the most recently connected PSCB.

19. The method according to claim 13 further including the step of optionally recirculating a terminated session with a restarted timer value to increase the length of time that data in that session is retained.

20. The method according to claim 13 further including a FIFO of soft entries which are attached to the search tree wherein the soft entries are removed based on the oldest FIFO entry.

21. The method according to claim 20 wherein active entries attached to the search tree are not removed from the tree, entries in a free queue may be made available for immediate reuse and soft entries attached to the search tree are removed and reused by new entries in the event no entries in the free queue are available.

22. A system for managing dynamic data search structures comprising:
a) a search structure containing multiple data entries, at least one data entry comprising an active session;
b) a first timer loop to maintain active sessions;
c) a free queue for the first timer loop, said free queue having available sessions for new entries in the search tree and for removal of obsolete sessions from the search tree;
d) a FIFO list of soft entries in a maximum segment lifetime (MSL) state;
e) a second timer loop to maintain sessions in a (MSL) state; and
f) a free queue for the second timer loop for moving an active session from the active state to the MSL state.

23. The system according to claim 22 further including the capability of removing the oldest MSL entry to accommodate information on a connection entry for deletion of an active session entry.

24. The system according to claim 22 further including a pool of spare buffers for adjusting timer requirements in the first free queue and the second free queue.

25. The system according to claim 22 wherein the maximum segment lifetime is two minutes.

26. A method for managing dynamic data search structures comprising:
a) providing a search structure containing multiple data entries, at least one data entry comprising an active session;
b) providing a first timer loop to maintain active sessions;
c) providing a free queue for the first timer loop, said free queue having available sessions for new entries in the search tree and for removal of obsolete sessions from the search tree;
d) providing a FIFO list of soft entries in a maximum segment lifetime (MSL) state;
e) providing a second timer loop to maintain sessions in a (MSL) state; and
f) providing a free queue for the second timer loop for moving an active session from the active state to the MSL state.

27. The method according to claim 26 including the further step of removing the oldest MSL entry to accommodate information on a connection entry for deletion of an active session entry.

28. The method according to claim 26 including providing a pool of spare buffers for adjusting timer requirements in the first free queue and the second free queue.

29. The method according to claim 26 wherein the maximum segment lifetime is two minutes.

30. A computer readable medium containing instructions for managing dynamic data search structures, the medium enabling a free queue to provide available sessions for new entries in a search structure and for removing obsolete sessions from said search structure.

31. The computer medium according to claim 30 including instructions to remove obsolete sessions from an active list to a 2MSL soft entry state and to maintain a FIFO list of soft entries.

32. The computer medium according to claim 31 further providing instructions to enable the oldest entry on the FIFO list to be removed to make room for a new session entry.

33. A data search structure wherein the data entries comprise active entries, and one or more soft entries that are in a maximum segment lifetime state and that are available for use for new entries,
said active entries are joined together to form one timing loop,
said soft entries are joined together to form another loop, and
one or more available entries outside of the loops that are used for new entries ahead of soft entries.

34. The search structure according to claim 33 wherein the available entries are chained to one another in a first FIFO queue that determines their availability for use for new entries.

35. The search structure according to claim 34 wherein the soft entries are chained together in a second FIFO queue and are used in that order for a new entry if the list of available entries in the first FIFO queue is empty.
